(19) United States
(12) Patent Application Publication
(10) Pub. No.: US 2010/0233047 A1
(43) Pub. Date: Sep. 16, 2010

(54) HORIZONTAL REACTOR FOR REACTING A FLUID EDUCT STREAM WITH A FLUID OXIDANT STREAM IN THE PRESENCE OF A SOLID CATALYST

(75) Inventors: Gerhard Olbert, Dossenheim (DE); Franz Corr, Ludwigshafen (DE); Sven Crone, Limburgerhof (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/739,829

(22) PCT Filed: Oct. 24, 2008
(86) PCT No.: PCT/EP2008/064412

§ 371 Date: Apr. 26, 2010

(30) Foreign Application Priority Data
Oct. 30, 2007 (EP) 0711959.1

(51) Int. Cl. B01J 8/04

(52) U.S. Cl. 422/190

(57) ABSTRACT

A reactor (1) for reacting a fluid feed stream (2) with a fluid oxidant stream (3) in the presence of a solid catalyst (4) in two or more stages over two or more fixed catalyst beds (5) which are arranged horizontally, parallel to the longitudinal axis of a cylindrical reactor wall (6) in the interior space thereof, with caps (7) being installed in a detachable fashion at the ends of the reactor wall (6), with the fluid feed stream (2) flowing through the reactor (1) from the top downward, wherein
the two or more fixed catalyst beds (5) are each formed by a plurality of modules, comprising
in each case a cuboidal frame (8) which extends over the entire height of the fixed catalyst bed and in which
one or more lower screens (9) and an upper screen (10) are installed and
the solid catalyst (4) is present between the one or more lower screens (9) and the upper screen (10),
all modules of a fixed catalyst bed (5) are enclosed in a cuboidal outer frame (11) which is arranged horizontally in the reactor (1) and extends essentially over the entire length and the entire width of the reactor (1) with the exception of the caps, and
a mixing-in apparatus (12) for the fluid oxidant stream (3) is provided upstream of each fixed catalyst bed (5),
   is proposed.

The invention relates to a horizontal reactor for reacting a fluid feed stream with a fluid oxidant stream in the presence of a solid catalyst in two or more stages over two or more fixed catalyst beds.

Reactions of fluid starting materials with a fluid oxidant stream over a fixed-bed catalyst are usually carried out in upright reactors in which the solid catalysts are present as catalyst beds through which the reactants flow axially or radially. Here, the introduction and mixing-in of the fluid oxidant stream, in particular oxygen, air or mixtures thereof with steam, generally has to be effected very uniformly over the entire entry area into the catalyst upstream of the catalyst beds, with very little inhomogeneity of the mixture and within a very short time, frequently less than 0.1 second, in order to suppress secondary reactions, in particular flame formation, cracking, soot formation, etc.

These requirements are virtually impossible to realize in the case of vertical axial reactors and can be realized only with great difficulty in radial reactors.

Horizontal fixed-bed reactors, i.e. reactors having a horizontal longitudinal axis and generally a cylindrical shape, are better suited to meeting the above requirements. Known horizontal solid reactors are the Catofin® reactor of ABB Lummus which has a fixed catalyst bed but the disadvantage that only a short period of operation is possible before the reactor has to be shut down in order to regenerate the catalyst or horizontal reactors having a plurality of catalyst beds which are arranged in series in the longitudinal direction and are connected via internal channels, in particular with heat exchangers arranged in between, e.g. the horizontal methanol converter of Casale or the horizontal ammonia converter of Kellogg.

In the light of the above, it was an object of the invention to provide an improved horizontal reactor for reacting a fluid feed stream with a fluid oxidant stream in the presence of a solid catalyst, which ensures, in particular, improved premixing of the fluid feed stream with the fluid oxidant stream in a mixing-in apparatus.

The object is achieved by a horizontal reactor for reacting a fluid feed stream with a fluid oxidant stream in the presence of a solid catalyst in two or more stages over two or more fixed catalyst beds which are arranged horizontally, parallel to the longitudinal axis of a cylindrical reactor wall in the interior space thereof, with caps being installed in a detachable fashion at the ends of the reactor wall and the fluid feed stream flowing through the reactor from the top downward, wherein
the two or more fixed catalyst beds are each formed by a plurality of modules, comprising
in each case a cuboidal frame which extends over the entire height of the fixed catalyst bed and in which
one or more lower screens and an upper screen are installed and
the solid catalyst is present between the one or more lower screens and the upper screen,
all modules of a fixed catalyst bed are enclosed in a cuboidal outer frame which is arranged horizontally in the reactor and extends essentially over the entire length and the entire width of the reactor with the exception of the caps, and
a mixing-in apparatus for the fluid oxidant stream is provided upstream of each fixed catalyst bed, with the mixing-in apparatus being formed by the following elements:
a plurality of cuboidal frames having recesses which are enclosed
in a cuboidal outer frame having essentially the same geometry as the cuboidal frames and the cuboidal outer frame for accommodating the solid catalyst,
two or three rows arranged in series of tubes which are arranged essentially perpendicular to the inflow direction of the fluid feed stream, with turbulence generators which constrict the flow cross section for the fluid feed stream to from ½ to 1/10 being arranged on the outside of the tubes and the fluid oxidant stream being passed through the interior spaces of the tubes via two feed and distribution chambers of which one is arranged on each side on the interior wall of the reactor (1) and being injected via openings in the tubes into the fluid feed stream, and
a perforated plate located upstream of the tubes and
a perforated plate located downstream of the tubes.

The reactor ensures an excellent quality of mixing at a greatly reduced length of the mixing-in apparatus in the flow direction of the fluid feed stream and thus at very short residence times.

As is known, the term fluid refers to all liquids, vapors and gases which obey the rheological laws of nonsolid continua. The fluid starting materials in the present case are, in particular, gaseous or liquid starting materials, preferably gaseous starting materials, in particular hydrocarbons.

The fluid oxidant stream can comprise gases of differing compositions. The fluid oxidant stream comprises, in particular, air, oxygen or mixtures of oxygen or air with steam.

The volume flows of the fluid feed stream and the fluid oxidant stream are frequently very different, which makes the mixing task corresponding more difficult: the flow of the fluid oxidant stream can be, in particular, from 1 to 30% of the flow of the fluid feed stream, or from 5 to 20% of this.

The solid catalyst is located in two or more fixed catalyst beds, i.e. it is a heterogeneous catalyst relative to the fluid feed stream. The catalyst beds are arranged horizontally, parallel to the longitudinal axis of a cylindrical reactor wall in the interior space of the latter.

According to the invention, each of the fixed catalyst beds is formed by a plurality of modules which are arranged horizontally next to one another and each comprise a cuboidal frame which extends over the entire height of the fixed catalyst bed and in which one or more lower screens and an upper screen are installed, with a solid catalyst being present between the one or more lower screens and the upper screen.

The division of the fixed catalyst bed into modules by means of cuboidal frames ensures the mechanical stability of the bed. The cuboidal frames can be stiffened at their corners to improve their stability further.

The cuboidal frames are, in particular, made of metal sheets having a thickness sufficient to ensure stability, in particular in the range from 10 to 50 mm. A lower screen or a plurality of lower screens arranged one above the other, in particular with a mesh opening which decreases from the bottom upward, is/are installed in the cuboidal frames, with the mesh opening of a screen or the uppermost of the plurality of screens having to be smaller than the smallest diameter of the particles of the solid catalyst. The cuboidal modules are each covered at their upper end by a screen. The upper screen additionally serves to correct the flow of the reaction mixture through the reactor and also the pressure drop.

All modules of a fixed catalyst bed which are arranged horizontally in the longitudinal and transverse direction of the reactor are enclosed in a cuboidal outer frame which is arranged horizontally in the reactor and extends essentially over the entire length and the entire width of the reactor with the exception of the caps and also over the entire height of the fixed catalyst bed.

The modules forming the catalyst beds are preferably configured so that they can be removed from the reactor and can be charged from outside the reactor.

The solid catalyst which forms the fixed catalyst beds comprises shaped catalyst bodies composed of all-active catalyst material or shaped bodies supported on an inert material. The shaped catalyst bodies are, in particular, extrudates, rings or spheres.

In place of fixed catalyst beds, structured packings, in particular structured packings produced by honeycomb technicology, can also be used advantageously.

A mixing-in apparatus for the fluid oxidant stream is arranged upstream of each fixed catalyst bed, with the mixing-in apparatus being formed by the following elements:
a plurality of cuboidal frames having recesses which are enclosed
in a cuboidal outer frame having essentially the same geometry as the cuboidal frames and the cuboidal outer frame for accommodating the solid catalyst,
two or three rows arranged in series of tubes which are arranged essentially perpendicular to the inflow direction of the fluid feed stream, with turbulence generators which constrict the flow cross section for the fluid feed stream to from ½ to 1/10 being arranged on the outside of the tubes and the fluid oxidant stream being passed through the interior spaces of the tubes via two feed and distribution chambers of which one is arranged on each side on the interior wall of the reactor and being injected via openings in the tubes into the fluid feed stream, and
a perforated plate located upstream of the tubes and
a perforated plate located downstream of the tubes.

The turbulence generators arranged on the outside of the tubes can be structures of differing geometries, but it is essential that they increase the turbulence in the fluids flowing around the tubes. They can preferably be elements that are known for static mixers or can also be packing elements of distillation columns or, for example, crossed strips of sheet metal.

The tubes having turbulence generators on their outside are preferably finned tubes.

Finned tubes are known in chemical engineering and are used, in particular, as heat exchanger tubes. Finned tubes and their production are described, for example, in DE-A 1 950 246 or DE-A 2 131 085.

A finned tube is formed by a tube, generally a metal tube, which has a cylindrical outer wall and elongated strips, the fins, which have been attached, generally by welding, to the outer wall along a longitudinal edge of the strip. The fins are frequently attached in a spiral or helical fashion to the outer wall of the tube, but can also be attached in the longitudinal direction of the tube. They normally have a smooth continuous surface, but can also be perforated. They can be notched to the bottom, but also, advantageously, down to a fin base so as to form segments. Notched fins are particularly useful for increasing the turbulence. The segments can in this case have various geometries, for example in the form of rectangles, trapezoids, etc. The notches between the segments can be made with or without loss of material. The segments can particularly advantageously be rotated or slanted through or at an angle relative to the fin base in order to increase, by means of a pitch, the turbulence, in particular in the regions between the fins, viz. the fin channels, and correspondingly improve the mixing action.

A dense arrangement of fins over the length of the tube is advantageous; in particular, from 100 to 300 turns of the fins per meter of tube length can be provided.

It is advantageous to use tubes having an external diameter in the range from 25 to 150 mm, in particular from 20 to 50 mm.

The fin height based on the external diameter of the tubes is advantageously in the range from 1/10 to ½.

The fin thickness can advantageously be in the range from 0.3 to 1.5 mm.

In the case of notched fins, it is advantageous to form segments having a width in the range from 3 to 12 mm, preferably from 4 to 8 mm.

The tubes can have any cross section, for example circular, oval or polygonal, for example triangular.

The finned tubes are arranged parallel to one another in rows, with a row of finned tubes being located in one plane.

It has been found that two or three rows of finned tubes are particularly useful.

It is advantageous here to arrange the second row of finned tubes opposite the gaps in the first row, and in the case of three rows of finned tubes, to arrange the third row of finned tubes opposite the gaps in the second row of finned tubes. A heat transfer medium can advantageously be passed through the second and if appropriate also the third row of finned tubes. It is also possible to make the second and if appropriate also the third row of finned tubes of solid material having any cross section.

Finned tubes having the same geometry should be used within a row of finned tubes, but the geometry can vary within the rows of finned tubes.

The finned tubes have, on the outside of the tubes forming them, two diametrically opposite openings per fin channel in the fin channels between the fins at the places having the smallest distance to the neighboring finned tube in the row of finned tubes. The fluid oxidant is injected into the fluid starting material in the fin channels between the fins through these openings. A plurality of small-scale mixing chambers having high turbulence, particularly in the case of fins notched to form segments and to an even greater extent if the fin segments are angled, are thus made available in the fin channels. Excellent mixing in the micro range is achieved in this way.

A concentric insert tube having outflow openings arranged at suitable spacings on its outside can in each case advantageously be provided in the interior of the finned tubes in order to ensure predistribution of the second fluid feed stream over the length of the tube and thus also substantial temperature equalization.

The fluid oxidant stream is introduced into the interior spaces of the tubes via two feed and distribution chambers of which one is arranged on each side on the inner wall of the reactor.

A perforated plate is installed upstream of the rows of fin tubes, likewise perpendicular to the inflow direction of the fluid feed stream and thus essentially parallel to the plane formed by the rows of finned tubes.

The upstream perforated plate has openings whose total area based on the cross-sectional area of the inlet for the first fluid feed stream is preferably less than or equal to 0.5, in particular less than or equal to 0.3.

The upstream perforated plate is advantageously located at a distance from the inflow plane of the first row of finned tubes which is from 7 to 20 times the diameter of the openings in the upstream perforated plate.

The diameter of the openings in the upstream perforated plate is advantageously less than half the clear spacing of the fins between two successive turns.

The upstream perforated plate can be omitted if it is ensured that the gas stream is distributed largely uniformly over the reactor cross section.

The mixing-in apparatus has, in the outflow direction from it, a second, downstream perforated plate having openings whose diameter is greater than or equal to the diameter of the upstream perforated plate.

For the purposes of the present invention, perforated plates are largely flat components having openings of any cross section.

The ratio of the plate thickness of the two perforated plates, viz. the upstream perforated plate and the downstream perforated plate, based on the diameter of the openings in the perforated plates, is preferably in the range from 0.75 to 2.0.

The downstream perforated plate is advantageously located at a distance from the outflow plane of the last row of finned tubes which is from 0.75 to 2 times the diameter of the finned tubes of the last row of finned tubes.

The downstream perforated plate is advantageously located at a distance from the entry into the catalyst bed which is from 5 to 20 times the diameter of the openings in the plate.

The material from which the finned tubes and the perforated plates are made is preferably stainless steel; materials which are resistant to oxidation and, if appropriate, carburization at elevated temperature are particularly preferred.

The mixing-in apparatus is arranged essentially perpendicular to the flow direction of the fluid feed stream. This means that the fluid feed stream is introduced in the direction of the normal to the main plane of the mixing-in apparatus. However, the expression “essentially perpendicular” is intended to encompass deviations from the normal of ±5° or ±10°, or even ±30°.

The mixing-in apparatus can, at construction depths, i.e. distances between the upstream perforated plate and the downstream perforated plate, range from 100 to 200 mm, achieve excellent, virtually 100% quality of mixing together with a pressure drop in the fluid feed stream, frequently the reaction gas, in the order of 20 mbar, and a pressure drop in the fluid oxidant stream, which for safety reasons alone has to be under at least a slight subatmospheric pressure, in the range from about 50 to 100 mbar.

An extremely large number of injection points for the second fluid feed stream into the first fluid feed stream in the order of 10 000 injection points per m² is achieved.

The two or more fixed catalyst beds are preferably arranged above one another to form a stack without a spacing between them and each with a mixing-in apparatus located in front of them in the flow direction.

The outer frames of a mixing-in apparatus and the fixed catalyst bed which directly follows it preferably have a tongue-and-groove connection. This achieves lateral sealing against the reactor wall. The tongue-and-groove connections are preferably provided with a degree of play in order to be able to accommodate thermal expansion.

The lower end of the fixed catalyst beds is preferably provided with a line for taking up a substream of the product mixture and feeding it via an inlet into the tubes of a heat exchanger and an outlet is also provided for the substream of the product mixture from the heat exchanger, with the substream of the product mixture circulating in the tubes of the heat exchanger preheating the fluid feed stream which ascends in the intermediate space between the tubes of a first tube bundle of the heat exchanger, descends via a connecting cap through the intermediate spaces between the tubes of a second tube bundle and finally leaves the heat exchanger as preheated feed stream and with the remaining substream of the product mixture which has not been passed through the tubes of the heat exchanger being recycled via the mixing-in apparatuses and the fixed catalyst beds.

The recycling of the substream of the product mixture which is not passed through the heat exchanger is preferably effected via one or more, preferably two, driving jet nozzles which are driven by the preheated feed stream.

The fixed catalyst beds and mixing-in apparatuses are advantageously mounted on a support construction which is open for fluids and is located underneath them and supported on rollers. In this way, the entire stack of fixed catalyst beds and mixing-in apparatuses can be pulled out after disconnection of the feed lines and the extraction and replacement of catalyst can be carried out in a very simple way by removing or assembling the individual fixed catalyst beds and mixing-in apparatuses.

The reactor of the invention is superior to a vertical radial reactor of the same capacity both in terms of the total capital cost and also in terms of the operating costs which are in each case only about 0.7 times those for the vertical radial reactor.

The reactor of the invention is preferably suitable for carrying out oxidation reactions with intermediate introduction of oxidant. Particular preference is given to using the reactor of the invention for dehydrations, in particular of propane or butane.

The invention is illustrated below with the aid of a drawing.

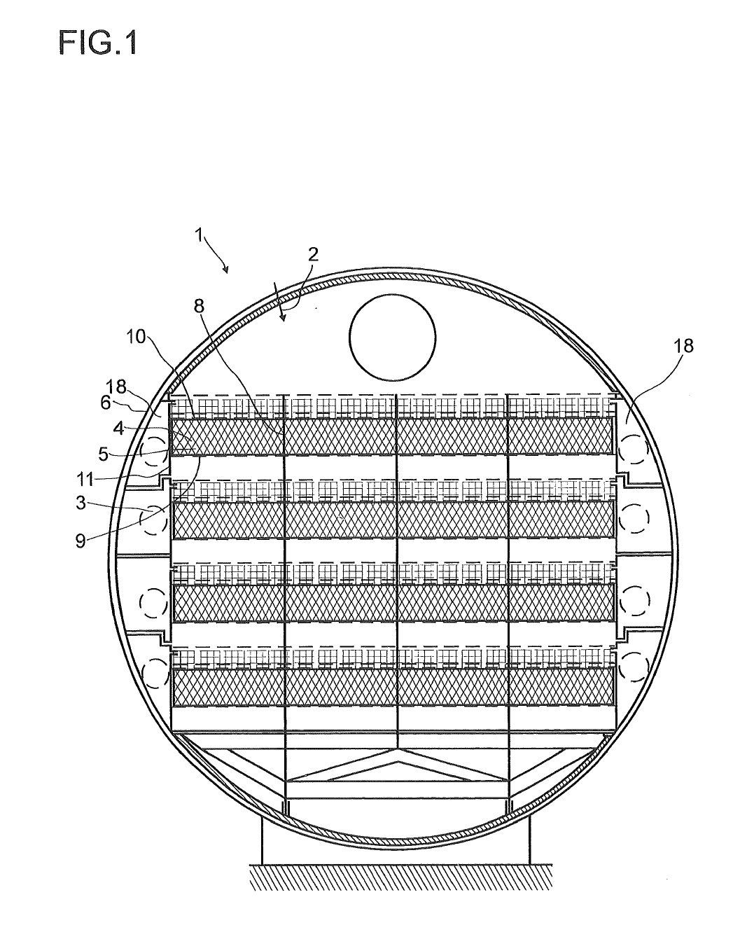

FIG. 1 shows a cross section through a horizontal reactor according to the invention,

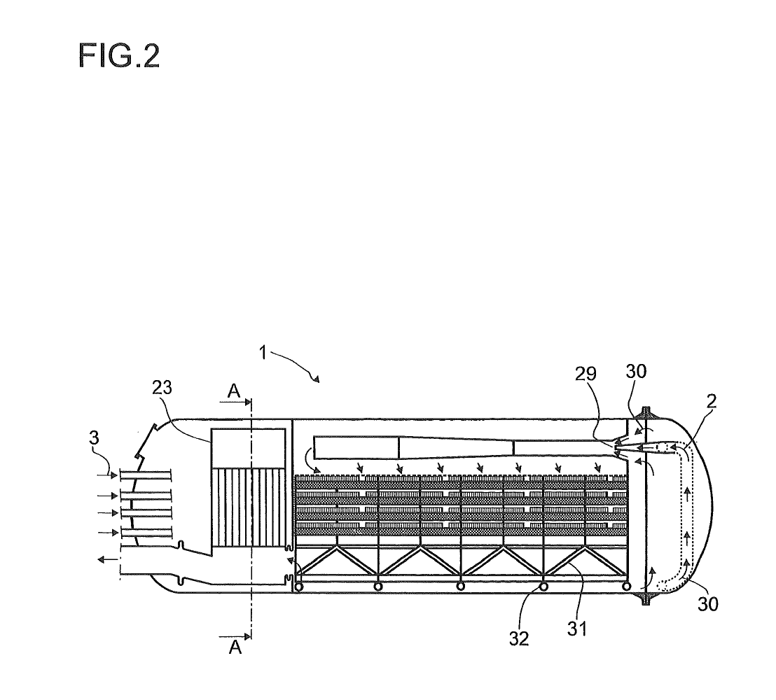

FIG. 2 shows a longitudinal section through a preferred embodiment of a reactor according to the invention, with the cross section in the plane A-A through the heat exchanger 23 in FIG. 2A,

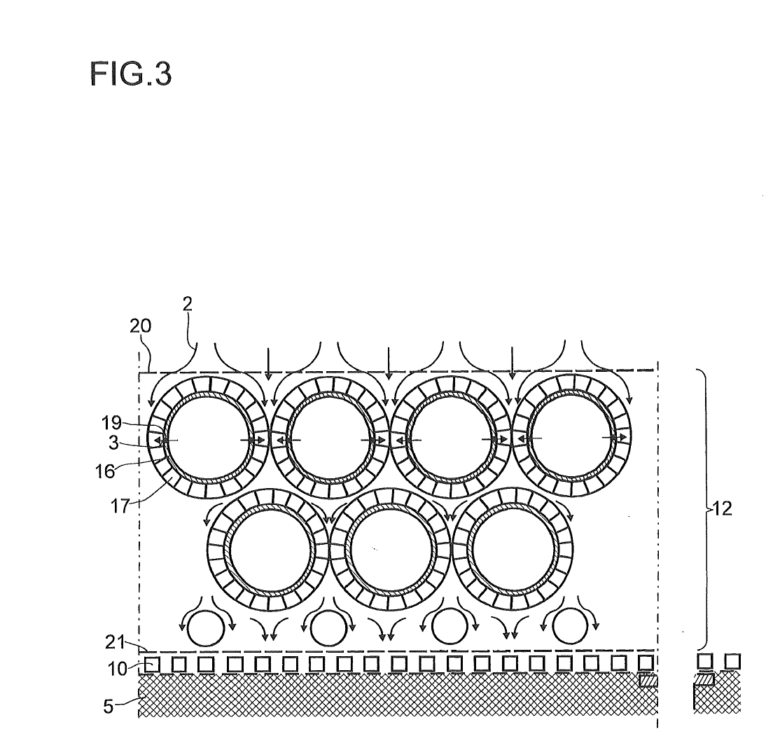

FIG. 3 shows a part of a cross section through a preferred embodiment of a mixing-in apparatus for a reactor according to the invention,

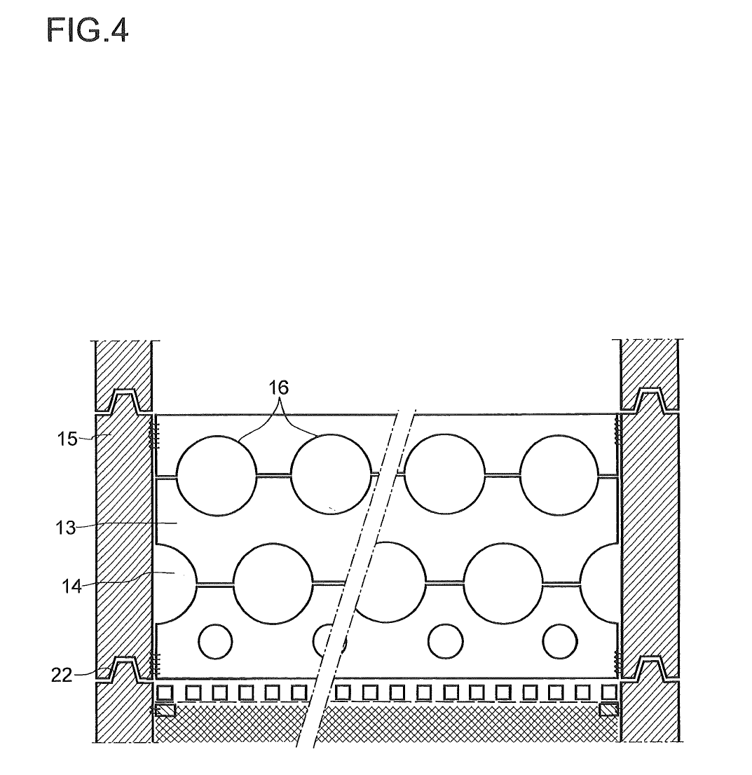

FIG. 4 shows a further part of a cross section through a reactor according to the invention and shows the cuboidal frame 13 for the mixing-in apparatus 12, and

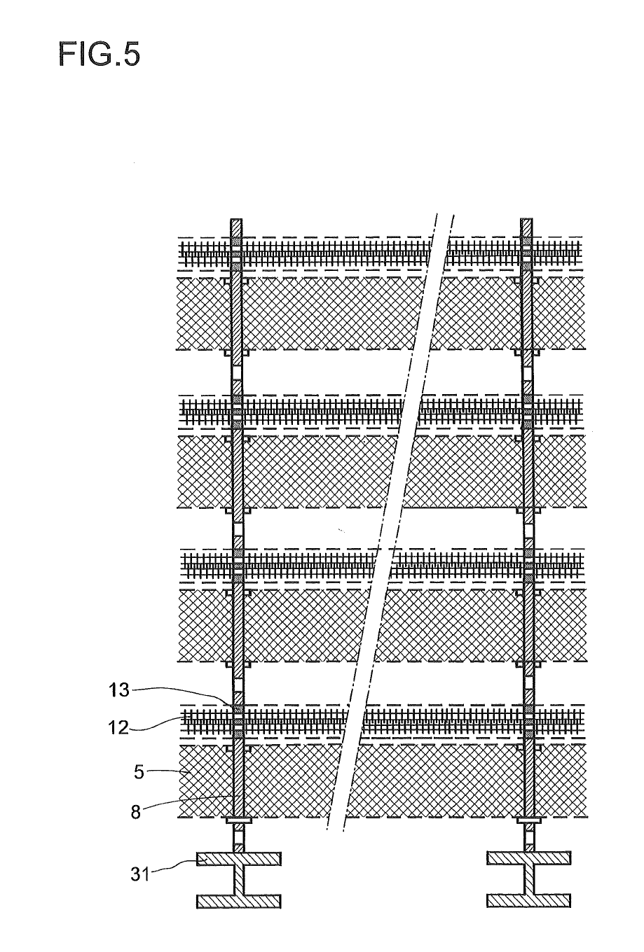

FIG. 5 shows a cross section in the vertical direction through a preferred embodiment of a reactor according to the invention.

FIG. 1 depicts a cross section through a preferred embodiment of a horizontal reactor 1 having a cylindrical reactor wall 6, with introduction of a fluid feed stream 2 into the reactor from above and introduction of a fluid oxidant stream 3 into mixing-in apparatuses 12 via feed and distribution chambers 18.

The preferred embodiment depicted in cross section in FIG. 1 displays, by way of example, four superposed fixed catalyst beds 5 of the solid catalyst 4 which are each formed by a plurality of modules of which, in the preferred embodiment depicted in the figure, four modules are present per fixed catalyst bed 5. The modules each comprise a cuboidal frame 8 which extends over the entire height of the fixed catalyst bed 5 and in which one or more lower screens 9 and an upper screen 10 are installed.

The preferred embodiment in FIG. 1 shows a support construction 31 which is mounted on rollers 32 for accommodating the stack of fixed catalyst beds 5 and mixing-in apparatuses 12.

FIG. 2 shows a preferred embodiment of a reactor 1 according to the invention in longitudinal section, with a cylindrical reactor wall 6 and caps 7 at both ends of the reactor.

The fluid feed stream 2 is fed via the heat exchanger 23 to the reactor 1 and heated by a substream 27 of the product stream in the heat exchanger 23. The cooled substream 28 of the product stream flows out from the heat exchanger 23. The fluid oxidant stream 3 is injected via mixing-in apparatuses 12 into the fluid feed stream 2 and the fluid feed stream 2 reacts with the fluid oxidant stream 3 in the presence of the solid catalyst 4 located in the catalyst beds 5. The figure shows, by way of example, four superposed catalyst beds, with eight modules in each case in the longitudinal direction of the reactor 1 and cuboidal frames 8 for accommodating the solid catalyst 4.

The fluid feed stream 2 draws in a recycle substream 30 of the product stream by means of a driving jet nozzle 29 and conveys it through the fixed catalyst beds 5 again.

A support construction 31 for the stack of fixed catalyst beds 5 and mixing-in apparatuses 12 with rollers 32 is provided in the lower region of the reactor.

The cross section through the reactor in the plane A-A in FIG. 2A shows the construction of the heat exchanger 23 with two tube bundles. The fluid feed stream 2 is passed through the intermediate space 25 between the tubes 24 of the heat exchanger 23, upward in a first of the two tube bundles and downward in the second of the two tube bundles of the heat exchanger 23, and leaves the heat exchanger 23 as preheated feed stream.

A substream of the product stream is conveyed via an inlet 27 through the tubes of the second tube bundle of the heat exchanger 23 from the bottom upward and conveyed further via a connecting cap 26 between the two tube bundles of the heat exchanger 23 through the tubes of the first tube bundle of the heat exchanger 23 from the top downward and leaves the heat exchanger 23 via the outlet 28. The feed stream 2 and the substream of the product stream thus circulate in countercurrent through the heat exchanger 23. The cross section in FIG. 2A also shows feed lines for the fluid oxidant stream 3.

FIG. 3 shows a part of a cross section in the vertical direction through a horizontal reactor 1, clearly showing the configuration of the mixing-in apparatus 12. The mixing-in apparatus 12 is arranged before, in the flow direction of the fluid feed stream 2, a fixed catalyst bed 5 on which an upper screen 10 is provided.

The mixing-in apparatus 12 comprises two rows of tubes 16 which are arranged in series and are arranged horizontally in the transverse direction of the reactor and also a perforated plate 20 located upstream of the tubes 16 and a perforated plate 21 located downstream of the tubes 16. In the preferred embodiment shown in FIG. 3, a further row of displacement tubes which have a smaller cross section than the tubes 16 and serve to equalize the flow is present in addition to the two rows of tubes 16. The tubes 16 are arranged essentially perpendicular to the inflow direction of the fluid feed stream 2. They have turbulence generators 17 on their outside which constrict the free flow cross section for the fluid feed stream 2 to from ½ to 1/10 of the original free flow cross section. The fluid oxidant stream 3 flows from the tubes 16 via openings 19 into the fluid feed stream 2.

FIG. 4 shows a further part of a cross section through a reactor 1 according to the invention in the vertical direction, enabling a cuboidal frame 13 with recesses 14 for accommodating the tubes 16 of the mixing-in apparatus 12 to be seen clearly. The solid catalyst 4 forms the solid catalyst bed 5 which is covered by the upper screen 10. The cuboidal outer frame 11 for the fixed catalyst bed 5 is, in the preferred embodiment depicted in the figure, connected via a tongue-and-groove connection 22 to the cuboidal outer frame 15 of the mixing-in apparatus 12. In addition, the figure shows a weld for connecting the cuboidal frame 13 of the mixing-in apparatus 12 to the cuboidal outer frame 15.

FIG. 5 shows a part of a cross section in the vertical direction through a preferred embodiment of a reactor 1 according to the invention having, by way of example, four superposed fixed catalyst beds 5 which are each bounded by a lower screen 9 and an upper screen 10, a cuboidal frame 8 for accommodating the solid catalyst 5 and mixing-in apparatuses 12 which are installed in cuboidal frames 13. The figure shows a support construction 31 for the stack of four fixed catalyst beds 5 and mixing-in apparatuses 12 in the region of the cuboidal frames 8 for the module for accommodating the solid catalyst 4 and the cuboidal frames 13 for the mixing-in apparatus 12.

### List of Reference Numerals

1 Reactor

2 Fluid feed stream

3 Fluid oxidant stream

4 Solid catalyst

5 Fixed catalyst bed

6 Cylindrical reactor wall

7 Caps

8 Cuboidal frame for modules for accommodating the solid catalyst 4

9 Lower screen

10 Upper screen

11 Cuboidal outer frame for the fixed catalyst bed 5

12 Mixing-in apparatus for the fluid oxidant stream 3

13 Cuboidal frame for the mixing-in apparatus 12

14 Recesses in the cuboidal frame 13 for accommodating the tubes 16

15 Cuboidal outer frame for the mixing-in apparatus 12

16 Tubes for the fluid oxidant stream 3

17 Turbulence generators on the outside of the tubes 16

18 Feed and distribution chambers for the fluid oxidant stream 3

19 Openings in tubes 16

20 Perforated plate located upstream of the tubes 16

21 Perforated plate located downstream of the tubes 16

22 Tongue-and-groove connection for the outer frames 11 and 15

23 Heat exchanger

24 Tubes of the heat exchanger 23

25 Intermediate space between the tubes 24 of the heat exchanger 23

26 Connecting cap between the two tube bundles of the heat exchanger 23

27 Inlet for the substream of the product stream into the heat exchanger 23

28 Outlet for the substream of the product stream from the heat exchanger 23

29 Driving jet nozzle

30 Recycle substream of the product stream

−Support construction for the stack of fixed catalyst beds 5 and mixing-in apparatuses 12

32 Rollers for the support construction 31

1.-10. (canceled)

11. A horizontal reactor for reacting a fluid feed stream with a fluid oxidant stream in the presence of a solid catalyst in two or more stages over two or more fixed catalyst beds which are arranged horizontally, parallel to the longitudinal axis of a cylindrical reactor wall in the interior space thereof, with caps being installed in a detachable fashion at the ends of the reactor wall, wherein
the two or more fixed catalyst beds are each formed by a plurality of modules, comprising
in each case a cuboidal frame which extends over the entire height of the fixed catalyst bed and in which
one or more lower screens and an upper screen are installed and
the solid catalyst is present between the one or more lower screens and the upper screen,
all modules of a fixed catalyst bed are enclosed in a cuboidal outer frame which is arranged horizontally in the reactor and extends essentially over the entire length and the entire width of the reactor with the exception of the caps, and
a mixing-in apparatus for the fluid oxidant stream is provided upstream of each fixed catalyst bed, with the mixing-in apparatus being formed by the following elements:
a plurality of cuboidal frames having recesses which are enclosed
in a cuboidal outer frame having essentially the same geometry as the cuboidal frames and the cuboidal outer frame for accommodating the solid catalyst,
two or three rows arranged in series of tubes which are arranged essentially perpendicular to the inflow direction of the fluid feed stream, with turbulence generators which constrict the free flow cross section for the fluid feed stream to from ½ to 1/10 being arranged on the outside of the tubes and the fluid oxidant stream being passed through the interior spaces of the tubes via two feed and distribution chambers of which one is arranged on each side on the interior wall of the reactor and being injected via openings in the tubes into the fluid feed stream, and
a perforated plate located upstream of the tubes and
a perforated plate located downstream of the tubes.

12. The reactor according to claim 11, wherein the fluid feed stream flows through the reactor from the top downward.

13. The reactor according to claim 11, wherein the tubes having turbulence generators on their outside are finned tubes, with the turbulence generators being configured as fins and the openings into the tubes being located in the fin channels between the fins.

14. The reactor according to claim 11, wherein the tubes constrict the free flow cross section for the fluid feed stream to from one third to one sixth of the original free flow cross section.

15. The reactor according to claim 11, wherein the two or more fixed catalyst beds are arranged above one another to form a stack without a spacing between them and each with a mixing-in apparatus located in front of them in the flow direction.

16. The reactor according to claim 11, wherein the outer frames of a mixing-in apparatus and the fixed catalyst bed which directly follows it have a tongue-and-groove connection.

17. The reactor according to claim 11, wherein the lower end of the fixed catalyst beds is provided with a line for taking up a substream of the product mixture and feeding it via an inlet into the tubes of a heat exchanger, an outlet for the substream of the product mixture from the heat exchanger is provided and the substream of the product mixture circulating in the tubes of the heat exchanger preheats the fluid feed stream which ascends in the intermediate space between the tubes of a first tube bundle of the heat exchanger, descends via a connecting cap through the intermediate spaces between the tubes of a second tube bundle and finally leaves the heat exchanger as preheated feed stream, with the remaining substream of the product mixture which has not been conveyed through the tubes of the heat exchanger being recycled via the mixing-in apparatuses and the fixed catalyst beds.

18. The reactor according to claim 17, wherein the recycling of the substream of the product mixture which is not conveyed through the heat exchanger is effected by means of one or more driving jet nozzles which are driven by the feed stream.

19. The reactor according to claim 11, wherein the fixed catalyst beds and mixing-in apparatuses are mounted on a lower support construction which is open for fluids and is supported on rollers.

20. The reactor according to claim 11, wherein structured packings are used in place of fixed catalyst beds.
